(19) United States
(12) Patent Application Publication
(10) Pub. No.: US 2009/0248841 A1
(43) Pub. Date: Oct. 1, 2009

(54) UNIQUE PREFIX ASSIGNMENT WITH AUTOMATIC ADDRESS CONFIGURATION

(75) Inventors: Paula Tjandra, Hoffman Estates, IL (US); Anand S. Bedekar, Arlington Heights, IL (US); Philip R. Roberts, Palatine, IL (US); Ajoy K. Singh, Round Lake, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/057,474

(22) Filed: Mar. 28, 2008

(51) Int. Cl. G06F 15/16

(52) U.S. Cl. 709/220

(57) ABSTRACT

A method (500) and a system (300) for implementing point-to-point communications. The method can include identifying at least a first portion (348, 350) of a prefix (344, 346) of a network address, the prefix corresponding to a particular topological region (326, 328) of a communications network (302). The method further can include generating a unique prefix (360, 362) by updating the prefix with an identifier (356, 358) that is unique within the topological region of the communications network, and assigning the unique prefix to a node (304-314) of the communications network.

### BACKGROUND OF THE INVENTION

1. Field of the Invention

The present invention generally relates to communication systems and, more particularly, to network address assignments.

2. Background of the Invention

Internet Protocol version 6 (IPv6) has been introduced to rectify addressing issues present in Internet Protocol version 4 (IPv4). IPv4 uses 32-bit IP addresses, which provides an address space of approximately 4.3 billion (4.3×10⁹) IP addresses. This number of IP addresses is not adequate for the expected growth of the Internet. Indeed, the number of available IPv4 addresses is quickly dwindling. In contrast, IPv6 uses 128-bit IP addresses, which provides a significantly larger address space. Specifically, IPv6 allows for approximately 340 undecillion (3.4×10³⁸) IP addresses, which is more than adequate for the foreseeable future.

The structure of a conventional IPv6 address 100 is shown in FIG. 1. The first portion of the IPv6 address 100 represents a prefix 102 that is used to rout IP packets to a particular communications network, and the final portion represents an interface identifier 104 intended to uniquely identify an individual interface on a host in the network. The first n-bits of the prefix 102 typically represent a network identifier 106, which is similar to an IPv4 network identifier. The remaining m-bits of the prefix 102 typically represent a subnet identifier 108, which may be used to identify subnets within the network.

The flexibility provided by the IPv6 addressing architecture allows both a point-to-point link model and a shared link model to be established. In the shared link model, the prefix 102 is shared amongst a plurality of devices in a particular network, while each device is randomly assigned its own interface identifier 104 for individual device identification. In general, there is some level of risk that two or more devices sharing a common prefix 102 may also be assigned the same interface identifier 104. Accordingly, a duplicate address detection procedure is typically required so that a corrective action can be implemented when duplicate interface identifiers, or address collisions, are detected.

In the point-to-point link model, the prefix 102 assigned to each communication device is unique so as to emulate a point-to-point link environment. In particular, each communication device is assigned a unique network identifier 106, which ensures that a unique IP address is assigned to each communication device, regardless of whether a plurality of devices share the same interface identifier 104. Duplicate address detection therefore is not required in the point-to-point link model, which reduces initial network entry and handover latency. Accordingly, many communication standards implementing the IPv6 protocol now require a unique prefix 102 to be assigned to each communication device communicating in a communications system. Examples of such communications standards include the Fourth-Generation Communications System (4G), Worldwide Interoperability for Microwave Access (WiMAX), the 3rd Generation Partnership Project (3GPP), 3GPP2 and digital subscriber line (DSL).

Since IPv6 packets are routed over the Internet using the 64-bit prefix 102 assigned to the target network, existing solutions for assignment of unique prefixes 102 to individual devices within the network generally are not available without the implementation of special functionality in data path devices (e.g. routers) to support creation of a network tunnel to each of the communication devices. Such functionality can be very expensive to implement.

### SUMMARY OF THE INVENTION

The present invention relates to a method of implementing point-to-point communications. The method can include identifying at least a first portion of a prefix of a network address, the prefix corresponding to a particular topological region of a communications network. The method further can include generating a unique prefix by updating the prefix with an identifier that is unique within the topological region of the communications network, and assigning the unique prefix to a node of the communications network.

The present invention also relates to a communications system which includes an access point that identifies at least a first portion of a prefix of a network address, the prefix corresponding to a particular topological region of a communications network. The access point also can generate a unique prefix by updating the prefix with an identifier that is unique within the topological region of the communications network, and assign the unique prefix to a node of the communications network.

The present invention also relates to a communications system which includes a network controller that identifies at least a first portion of a prefix of a network address, the prefix corresponding to a particular topological region of a communications network. The network controller also can generate a unique prefix by updating the prefix with an identifier that is unique within the topological region of the communications network, and assign the unique prefix to a node of the communications network.

### BRIEF DESCRIPTION OF THE DRAWINGS

Various embodiments of the present invention will be described below in more detail, with reference to the accompanying drawings, in which:

FIG. 1 depicts an IPv6 address structure that is useful for understanding the prior art;

FIG. 2 depicts an IP address structure that is useful for understanding embodiments of the present invention;

FIG. 3 depicts a communications system that is useful for understanding embodiments of the present invention;

FIG. 4 is a signal flow diagram that is useful for understanding embodiments of the present invention; and

FIG. 5 is a flowchart that is useful for understanding embodiments of the present invention.

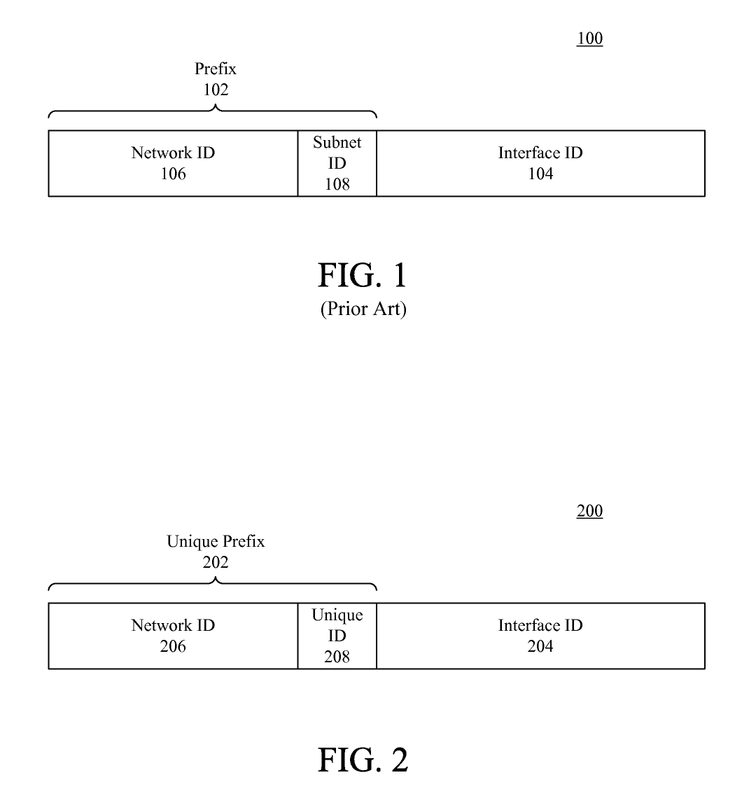

### DETAILED DESCRIPTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The present invention relates to a method and a system for automatically generating and assigning unique Internet Protocol (IP) prefixes to various nodes of a communications network. Thus, a dynamic point-to-point link model can be implemented to establish IP communication links between the network nodes and other devices internal and/or external to the communications network without requiring the use of a network tunnel. Moreover, such communication links can be established without requiring the use of a duplicate address detection procedure. Accordingly, IP communications can be implemented in a very cost effective manner.

FIG. 2 depicts the structure of an IP address 200 that is useful for understanding embodiments of the present invention. The IP address 200 can include a unique prefix 202 and an interface identifier 204. As used herein, a “unique prefix” is a prefix that is unique within a communications system. For example, a unique prefix can be unique among all prefixes assigned to nodes of the Internet. As opposed to a conventional unique prefix, the unique prefix 202 can be generated to include a first portion comprising a non-unique network identifier 206. As used herein, a “non-unique network identifier” is a network identifier that is not exclusively unique to a single network node. The non-unique network identifier 206 can be, for example, a network identifier assigned to a communications network, or a topological region of a communications network, in which a plurality of network nodes may be present at any given time.

To distinguish the unique prefix 202 from other prefixes using the same network identifier 206, the unique prefix 202 can include a second portion comprising a unique identifier 208 in lieu of a subnet identifier. As used herein, the term “unique identifier” means an identifier that is unique within at least one topological region of a particular communications network, for example within a topological region of a communications network identified by the network identifier 206. Selection of the unique identifier 208 will be discussed herein in greater detail.

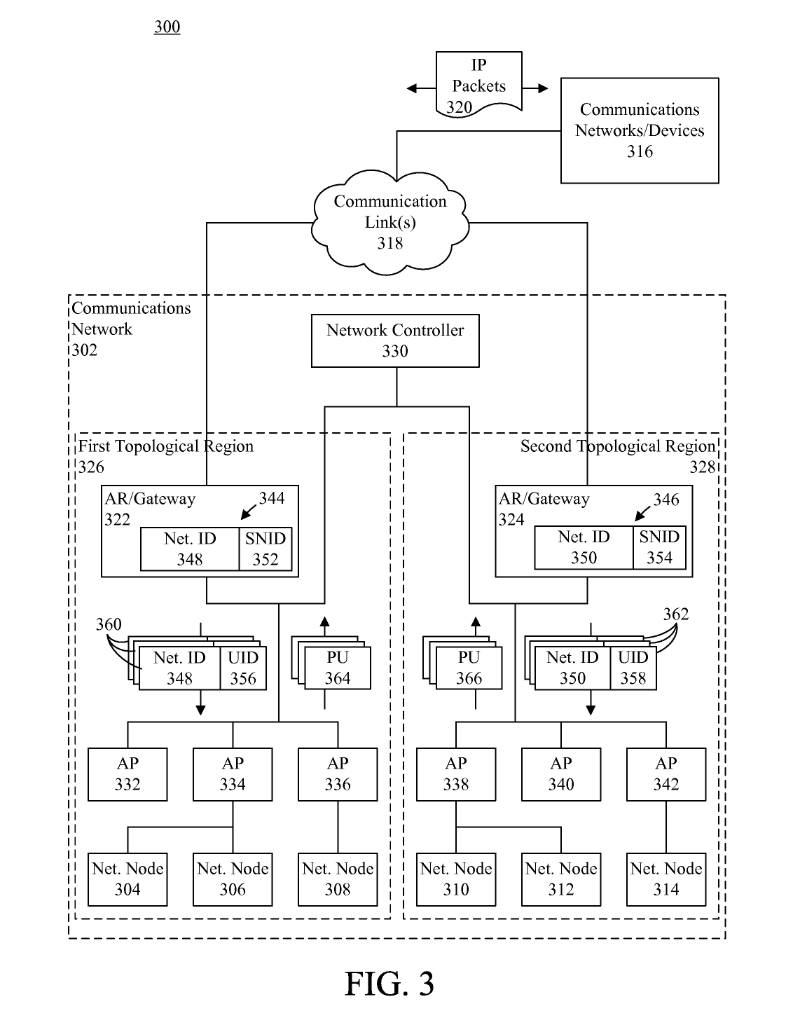

FIG. 3 depicts a communications system 300 that is useful for understanding embodiments of the present invention. The communications system 300 can include a communications network 302 in which a plurality of IP addresses having unique prefixes can be generated and assigned to respective network nodes 304, 306, 308, 310, 312, 314. Such network nodes can be, for example, wireless communication devices or wired communication devices. Examples of network nodes 304-314 can include, but are not limited to, computers, mobile stations (e.g. mobile radios, mobile telephones, mobile computers, personal digital assistants, or the like), network appliances, set top boxes, gaming devices, and so on.

The communications network 302 can comprise a wide area network (WAN), an interconnect communications network (e.g. a cellular communications network), a public switched telephone network (PSTN), and the like. The communications network also may comprise a local area network (LAN), a metropolitan area network (MAN), a WiFi network, a WiMAX network, a Mesh network, and/or any suitable other networks or systems over which communication signals can be propagated. In that regard, the communications network 302 can include wired and/or wireless communication links.

The communications network 302 can be configured to communicate data via IEEE 802 wireless communications, for example, 802.11 and 802.16, 3G, 4G, EUTRAN, UMB, WPA, WPA2, GSM, TDMA, CDMA, WCDMA, OFDM, direct wireless communication, or any other communications format. Indeed, the communications network 302 can be implemented in accordance with any suitable communications standards, protocols, and/or architectures, or a suitable combination of such standards, protocols, and/or architectures.

Further, the communications network 302 can be communicatively linked to one or more other communications networks/devices 316 via one or more communication links 318, for instance via the Internet. Over such communication links 318 the communications network 302 can exchange IP packets 320 with the communications networks/devices 316.

The communications network 302 can include one or more access routers and/or gateways (hereinafter collectively referred to as “routers”) 322, 324 that route, via the communication links 318, the IP packets 320 exchanged between the communications network 302 and the communications networks/devices 316. The routers 322, 324 can include any hardware, firmware and/or software suitable for implementing routing functionality. For instance, the routers 322, 324 can include one or more network adapters, one or more processors/controllers, and/or one or more data storage devices that store firmware/software. In one arrangement, each of the routers 322, 324 can service a different topological region of the communications network 302. For example, the router 322 can service a first topological region 326 and the router 324 can service a second topological region 328. At this point it should be noted that a topological region of a communications network may be, but is not necessarily, defined by a geographic region. For instance, the first topological region 326 can include all network components that have established network presence via the router 322, regardless of their respective physical locations.

The communications network 302 further can include a network controller 330 that provides management of network security and/or other network related functions. As such, the network controller 330 also can include any hardware, firmware and/or software suitable for implementing network control functionality. For example, if the communications network 302 is a radio access network, in one arrangement the network controller 330 can be a carrier access point controller (CAPC). If the communications network 302 implements a proxy mobile IPv6 (PMIPv6) communications protocol, the network controller 330 can be a local mobility anchor. In other arrangements the network controller 330 can be a network server. Still, the network controller 330 can be implemented in any other suitable manner and the invention is not limited in this regard.

One or more access points 332, 334, 336, 338, 340, 342 also can be provided in the communications network 302. The access points 332-342 can communicatively link respective network nodes 304-314 to the routers 322, 324. For example, the access points 332-342 can comprise wireless access points, switches, routers, or the like. Such components are well known to the skilled artisan.

In operation, each of the routers 322, 324 can be assigned a respective prefix 344, 346 comprising a network identifier 348, 350 and a subnet identifier 352, 354. In an arrangement in which IPv6 is implemented in the communications system 300, each of the network identifiers 348, 350 can have a bit length that is less than the bit length of the respective prefixes 344, 346, and can comprise a variable length prefix. It should be noted, however, that the network identifiers 348, 350 are not limited to the IPv6 format. Indeed, the network identifiers 348, 350 can be formatted in accordance with any other communication protocol(s) that may be implemented in the communications system 300.

The routers 322, 324 can advertise their prefixes 344, 346 for detection by the network controller 330. The network controller 330 then can generate unique identifiers 356, 358 which may be used to update the prefixes 344, 346 to generate respective unique prefixes 360, 362 that may be assigned to the respective network nodes 304-308, 310-314. In one arrangement, the network controller 330 can update the prefixes 344, 346 to generate the unique prefixes 360, 362. In another arrangement, the network controller 330 can communicate the unique identifiers 356, 358 to one or more other network components, such as the access points 332-342, and such network components can update the prefixes 344, 346 to generate the unique prefixes 360, 362. Such network components can receive the prefixes 344, 346 from the routers 322, 324 as an advertisement, or can receive the prefixes 344, 346 from the routers 322, 324 when establishing presence on the communications network 302.

To generate the unique prefixes 360, 362, the network identifiers 348, 350 can be parsed from the prefixes 344, 346, and unique identifiers 356, 358 can be appended to the network identifiers 348, 350. Notably, the unique identifier 356 for each successive unique prefix 360 will be different, while each of the unique prefixes 360 can share the same network identifier 348. Similarly, the unique identifier 358 for each successive unique prefix 362 will be different, while each of the unique prefixes 362 can share the same network identifier 350.

When the network nodes 304-314 establish presence on the communications network 302, for instance in accordance with a particular authentication protocol, the access points 332-342 with which they are communicatively linked can communicate to the network controller 330 requests for respective unique prefixes 360, 362 or unique identifiers 356, 358 that may be assigned to the network nodes 304-314. For example, if the network controller 330 is tasked with generating the unique prefixes 360, 362, the access points 332-342 can request the unique prefixes 360, 362. If, however, the access points 332-342 are tasked with generating the unique prefixes 360, 362, the access points 332-342 can request the unique identifiers 356, 358.

Each request can include, for instance, an identifier that identifies an interface of the network node 304-314 (hereinafter “interface identifier”) for which the request is being generated. The interface identifiers can be media access control (MAC) addresses, hashes, or any other suitable identifiers. The interface identifiers can be received from the network nodes 304-314 during authentication of the network nodes 304-314. In response, the network controller 330 can communicate the unique prefixes 360, 362 or unique identifiers 356, 358 to the appropriate access points 332-342, which can assign the unique prefixes 360, 362 to the network nodes 304-314.

By way of example, assume that the network identifier 348 assigned to the router 322 is 5f00:0000:c001 and the network identifier 350 assigned to the router 324 is 5f00:0000:c002. In such an arrangement, the unique prefixes 360, 362 can be assigned to the network nodes, for instance as indicated in Table 1.

TABLE 1

| Network | Network ID | Unique ID | Resulting Unique Prefix |
|---|---|---|---|
| Node | 348, 350 | 356, 358 | 360, 362 |
| 304 | 5f00:0000:c001 | 0001 | 5f00:0000:c001:0001/64 |
| 306 | 5f00:0000:c001 | 0002 | 5f00:0000:c001:0002/64 |
| 308 | 5f00:0000:c001 | 0003 | 5f00:0000:c001:0003/64 |
| 310 | 5f00:0000:c002 | 0001 | 5f00:0000:c002:0001/64 |
| 312 | 5f00:0000:c002 | 0002 | 5f00:0000:c002:0002/64 |
| 314 | 5f00:0000:c002 | 0003 | 5f00:0000:c002:0003/64 |

Although the network nodes 304-308 of the first topological region 326 of the communications network 302 share the same network identifier 348, the unique identifiers 356 distinguish each of such nodes 304-308. Similarly, while the network nodes 310-314 of the second topological region 328 of the communications network 302 also share the same network identifier 350, the unique identifiers 358 distinguish each of such nodes 310-314.

Moreover, although the network nodes 304, 310 may share the same unique identifier, such nodes can be distinguished from each other by their respective identifiers 348, 350. Similarly, the network identifiers 348, 350 can distinguish the network node 306 from the network node 312 and distinguish the network node 308 from the network node 314. Further, although a particular unique identifier may be re-used among different topological regions 326, 328 of the communications network 302, this need not be the case. Indeed, each unique prefix 360, 362 in the communications network 302 can include a unique identifier 356, 358 that is unique among all nodes 304-314 of the communications network 302, not just among nodes in a particular topological region 326, 328.

It also should be noted that the unique identifiers 356, 358 need not be assigned in a particular order or pattern. Notwithstanding, the unique identifiers 356, 358 assigned in a particular topological region 326, 328 should be selected such that the risk of two identical identifiers being active as unique identifiers 356, 358 in the same topological region 326, 328 is sufficiently low.

When the access points 332-342 assign the unique prefixes 360, 362 to the network nodes 304-314, the access points 332-342 can append interface identifiers corresponding to the respective network nodes 304-314 to each of the unique prefixes 360, 362, thereby creating network addresses having the network address structure 200 depicted in FIG. 2. Each interface identifier can be generated from the interface identifier of its corresponding network node using known techniques. The access points 332-342 then can map the network addresses to their corresponding network nodes to generate network address mappings. Since the network addresses contain the unique prefixes, the mapping of the network address to the network nodes effectuates mapping of the unique prefixes to the network nodes. Each access point 332-342 can maintain for a given period of time the network address mappings which it has generated, for instance in a respective data table or data file.

Further, the access points 332-342 can advertise the network address mappings to the corresponding routers 322, 324. For example, when the access point 334 maps a network address having a unique prefix 360 to the network node 306, the access point 334 can advertise the network address mapping to the router 322. In particular, the access point 334 can communicate to the router 322 a path update 364 comprising the unique identifier 356 and the interface identifier of the network node 306. The path update 364 can signal to the router 322 to update its path assignments. Similarly, when the access point 342 maps a network address having a unique prefix 362 to the network node 314, the access point 342 can communicate to the router 324 a path update 366 comprising the unique identifier 358 and the interface identifier of the network node 314. Notably, the path updates 364, 366 need not include the network identifiers 348, 350 since the routers 322, 324 have knowledge of their respective network identifiers 348, 350.

With the network addresses having unique prefixes 360, 362 mapped to the network nodes 304-314, each of such nodes 304-314 are available to communicate using point-to-point communication. As used herein, the term “point-to-point communication” means communication over a dedicated communication link that connects a respective network node 304-314 with exactly one other network node or communication facility. Notwithstanding, the network nodes 304-314 are not exclusively limited to communicating with a single network node or communication facility. If it is desired that a network node 304-314 communicate with a plurality of other network nodes or communication facilities, a plurality of dedicated communication links can be established with the network node 304-314.

When an outgoing IP packet 320 is communicated by a network node 304-314, such IP packet 320 can include the network node's assigned network address. When an incoming IP packet 320 is received by the communications network 302, the IP packet can be forwarded to the router 322, 324 that corresponds to the network identifier contained in the target network address. As noted, in IPv6 the network identifier can be contained in the first 48-bits of the network address. The remaining portions of the network address then can be used to route the IP packet 320 to the appropriate access point 332-342, which can forward the IP packet 320 to the appropriate network node 304-314 based on the network address mappings. In IPv6 the remaining portions can comprise the final 80-bits of the network address (e.g. a 16-bit unique identifier and a 64-bit interface identifier).

In order to ensure that an adequate number of unique prefixes 360, 362 are available as additional network nodes 304-314 establish presence on the communications network 302, the assignment of each unique prefix 360, 362 can expire after a given period of inactivity of the network node to which the unique prefix 360, 362 is assigned, or after a corresponding network node exits the communications network 302. Upon an assignment of a unique prefix 360, 362 expiring, the mapping of the unique prefix 360, 362 to a respective network node 304-314 can be released, and the corresponding unique identifier 356, 358 can be added to a pool of available unique identifiers.

Further, the network identifiers 348, 350 also can expire. For instance, if the network controller 330 fails to receive an advertisement from the router 322 at a scheduled interval, it can be assumed that the router 322 is offline. Accordingly, the network controller 330 can release all unique identifiers 356 assigned to the first topological region 326. Similarly, if the access points 332-336 fail to receive an advertisement from the router 322 at a scheduled interval, the access points 332-336 can release the network address mappings 364.

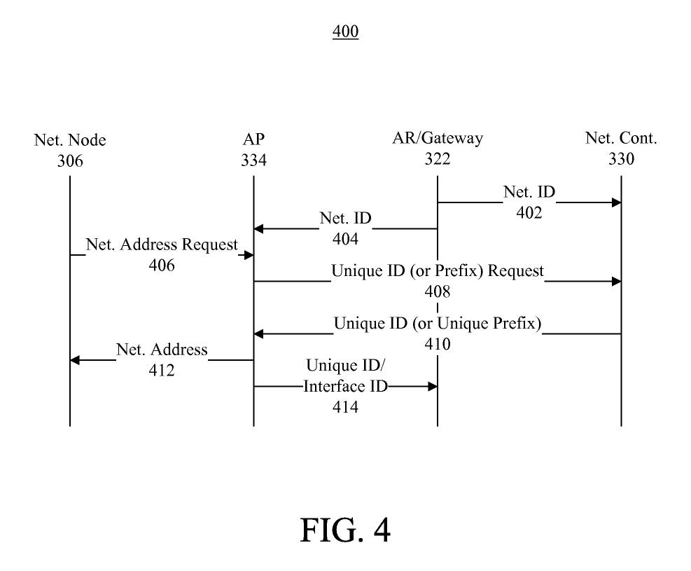

FIG. 4 is a signal flow diagram 400 that is useful for understanding embodiments of the present invention. At step 402 the router 322 can advertise its network identifier to the network controller 330. Similarly, at step 404 the router 322 can advertise the network identifier to the access point 334. At step 406 the access point 334 can receive a network address request from the network node 306. The network address request can indicate the interface identifier of the network node 306. In response, at step 408 the access point 334 can request a unique identifier (or unique prefix) from the network controller 330. At step 410, the network controller 330 can respond with an acknowledgement comprising the unique identifier (or unique prefix). At step 412 the access point 334 can respond to the network entry request received from the network node 306 with an acknowledgement comprising a network address having a unique prefix. At step 414 the access point 334 can communicate to the router 322 the unique identifier and the interface identifier contained in the network address assigned to the network node 306.

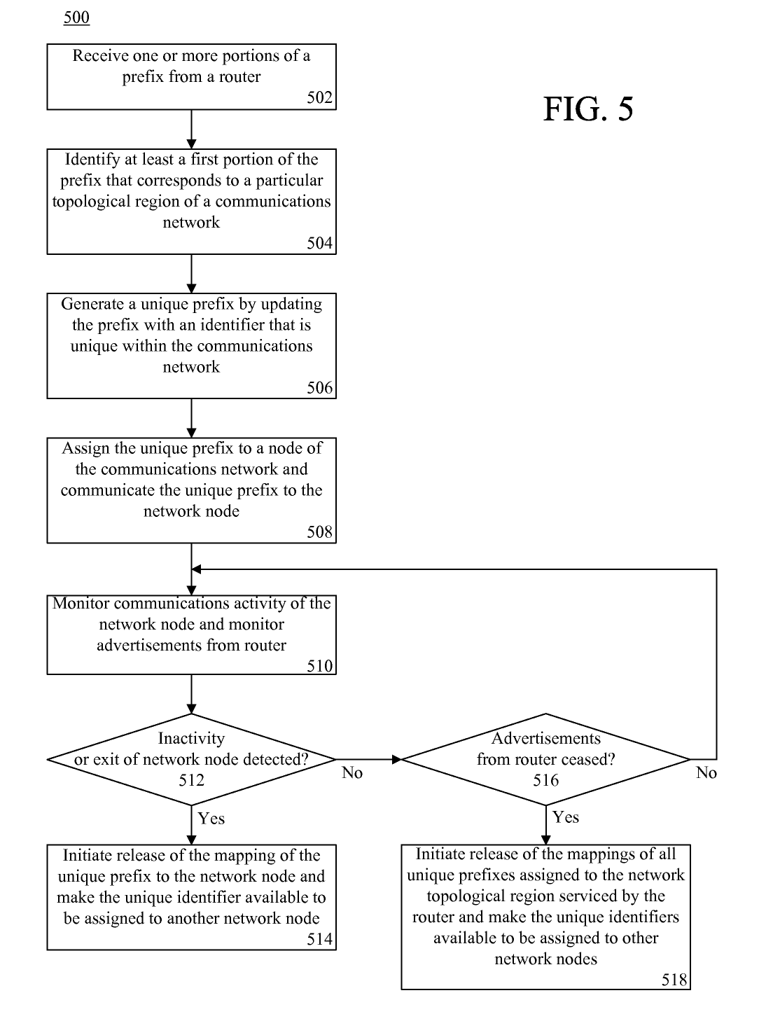

FIG. 5 is a flowchart presenting a method 500 that is useful for understanding embodiments of the present invention. At step 502, one or more portions of a prefix can be received from a router. The prefix can be received by, for example, an access point, a network controller or another suitable component of a communications network. As noted, the network controller can be a CAPC or a local mobility anchor and the router can be an access router or a gateway.

At step 504 at least a first portion of the prefix that corresponds to a particular topological region of a communications network can be identified, for example by the access point or the network controller. The topological region can be a portion of the communications network or the entire communications network. For instance, the prefix can be a prefix that is assigned to a particular router (e.g. an access router or gateway) within the communications network.

Proceeding to step 506, a unique prefix can be generated by updating the prefix with an identifier that is unique within the topological region of the communications network. For example, the prefix can be updated by appending the unique identifier to a first portion of the prefix. The prefix can be updated by the access point, the network controller, or another suitable network component. In an arrangement in which the prefix is updated by the access point, the access point can receive the unique identifier from the network controller. In that regard, the network controller can generate and maintain unique identifiers within the communications network.

At step 508 the unique prefix can be assigned to a node of the communications network, for example to a communications device establishing presence on the communications network. The unique prefix can be assigned by an access point, for instance by mapping the unique prefix to an interface identifier of the network node. The unique prefix then can be communicated to the network node for identification purposes.

Continuing to step 510, communications activity on the network node can be monitored by the access point or the network controller. In an arrangement in which the communications activity is monitored by the network controller, the network controller can communicate with the access point or router to receive data regarding the network node's activity on the communications network. The access point or network controller also can monitor for advertisements generated by the router.

Proceeding to decision box 512, if inactivity of the network node is detected, or the network node has exited from the communications network, at step 514 the network controller, the access point, or another suitable network component can initiate release of the mapping of the unique prefix to the network node. In an arrangement in which the network controller initiates such release, the network controller can signal the access point to release the mapping. The unique identifier then can be made available to be assigned to another network node. For example, the unique identifier can be returned to a pool of available unique identifiers. In an arrangement in which the access point initiates the release of the unique prefix mapping, the access point can indicate to the network controller to make the unique identifier available.

Referring to decision box 516, if advertisements received from the router cease, at step 518 the network controller can initiate release of the mappings of all unique prefixes assigned to the network topological region serviced by the router. The unique identifiers then can be made available to be assigned to other network nodes.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The present invention can be realized in hardware, software, or a combination of hardware and software. The present invention can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with an application that, when being loaded and executed, controls the processing system such that it carries out the methods described herein. The present invention also can be embedded in a program storage device readable by a machine, tangibly embodying a program of instructions executable by the machine to perform methods and processes described herein. The present invention also can be embedded in an application product which comprises all the features enabling the implementation of the methods described herein and, which when loaded in a processing system, is able to carry out these methods.

The terms “computer program,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a script, a subroutine, a function, a procedure, an object method, an object implementation, an executable application, an applet, a servlet, a MIDlet, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language).

This invention can be embodied in other forms without departing from the spirit or essential attributes thereof. Accordingly, reference should be made to the following claims, rather than to the foregoing specification, as indicating the scope of the invention.

What is claimed is:

1. A method of implementing point-to-point communications, comprising:
identifying at least a first portion of a prefix of a network address, the prefix corresponding to a particular topological region of a communications network;
generating a unique prefix by updating the prefix with an identifier that is unique within the topological region of the communications network; and
assigning the unique prefix to a node of the communications network.

2. The method of claim 1, wherein updating the prefix with the unique identifier comprises:
appending the unique identifier to the first portion of the prefix.

3. The method of claim 1, further comprising receiving the first portion of the prefix from an access router or gateway.

4. The method of claim 1, wherein assigning the unique prefix to the node of the communications network comprises assigning the unique prefix to a communication device establishing presence on the communications network.

5. The method of claim 1, wherein assigning the unique prefix to the node of the communications network comprises communicating the unique prefix to the network node.

6. The method of claim 1, wherein assigning the unique prefix to the node of the communications network comprises initiating a mapping of the unique prefix to an interface identifier of the network node.

7. The method of claim 6, further comprising communicating to at least one component of the communications network a path update that signals the component to update its path assignments.

8. The method of claim 6, further comprising:
monitoring communications activity of the node of the communications network; and
in response to detecting a period of inactivity of the network node or detecting that the network node has exited the communications network, initiating a release of the mapping of the unique prefix to the interface identifier of the network node.

9. The method of claim 8, further comprising making the unique identifier available to be assigned to at least one other node of the communications network.

10. The method of claim 6, further comprising:
monitoring advertisements generated by an access router or gateway of the communications network; and
in response to determining that the advertisements generated by the access router or gateway have ceased, initiating a release of all mappings of unique prefixes assigned to a network topological region serviced by the access router or gateway.

11. The method of claim 10, further comprising making all unique identifiers associated with the unique prefixes available to be assigned to other nodes of the communications network.

12. A communications system, comprising:
an access point that identifies at least a first portion of a prefix of a network address, the prefix corresponding to a particular topological region of a communications network, generates a unique prefix by updating the prefix with an identifier that is unique within the topological region of the communications network, and assigns the unique prefix to a node of the communications network.

13. The communications system of claim 12, wherein the access point updates the prefix with the unique identifier by appending the unique identifier to the first portion of the prefix.

14. The communications system of claim 12, wherein the access point receives the first portion of the prefix from an access router or gateway.

15. The communications system of claim 12, wherein the access point communicates the unique prefix to the network node.

16. The communications system of claim 12, wherein the access point monitors communications activity of the node of the communications network and, in response to detecting a period of inactivity of the network node or detecting that the network node has exited the communications network, initiates a release of the mapping of the unique prefix to the interface identifier of the network node.

17. A communications system, comprising:
a network controller that identifies at least a first portion of a prefix of a network address, the prefix corresponding to a particular topological region of a communications network, generates a unique prefix by updating the prefix with an identifier that is unique within the topological region of the communications network, and assigns the unique prefix to a node of the communications network.

18. The communications system of claim 17, wherein the network controller updates the prefix with the unique identifier by appending the unique identifier to the first portion of the prefix.

19. The communications system of claim 17, wherein the network controller receives the first portion of the prefix from an access router or gateway.

20. The communications system of claim 17, wherein the network controller monitors communications activity of the node of the communications network and, in response to detecting a period of inactivity of the network node or detecting that the network node has exited the communications network, initiates a release of the mapping of the unique prefix to the interface identifier of the network node.
